(19) United States
(12) Patent Application Publication
(10) Pub. No.: US 2005/0238328 A1
(43) Pub. Date: Oct. 27, 2005

(54) Optical disk playback apparatus

(75) Inventors: Yoshihide Morimoto, Saitama-ken (JP); Norio Harada, Tochigi-ken (JP)

Correspondence Address: SoCAL IP LAW GROUP LLP, 310 N. WESTLAKE BLVD. STE 120, WESTLAKE VILLAGE, CA, 91362, US

(73) Assignee: Sanyo Electric Co., Ltd., Osaka (JP)

(21) Appl. No.: 11/111,175

(22) Filed: Apr. 20, 2005

(30) Foreign Application Priority Data
Apr. 27, 2004 (JP) 2004-130820

(51) Int. Cl. H04N 5/781

(52) U.S. Cl. 386/95; 386/126

(57) ABSTRACT

An optical disk playback apparatus that can play a first optical disk in which audio data are recorded and output audio to a speaker, can play a second optical disk in which at least video data are recorded and output video to an external display device, and includes a display panel that can display an operational input status relating to the playback of the first optical disk, the optical disk playback apparatus including: a first operational input status outputting unit that outputs, to the external display device, a video signal for displaying at least operational input statuses relating to the playback of the first optical disk and the second optical disk; a display mode determining unit that determines, in accordance with an operational input that selects an internal display panel display mode that causes the operational input status of the first optical disk to be displayed on the display panel or an external display device display mode that causes that operational input status to be displayed on the display device, the display mode of these; and a second operational input status outputting unit which, when the internal display panel display mode has been selected, causes at least the operational input status of the first optical disk to be displayed on the display panel.

### CROSS-REFERENCE TO RELATED APPLICATIONS

The present application claims priority upon Japanese Patent Application No. 2004-130820 filed on Apr. 27, 2004, which is herein incorporated by reference.

### BACKGROUND OF THE INVENTION

1. Field of the Invention

The present invention relates to an optical disk playback apparatus.

b 2. Description of the Related Art

DVD (digital versatile disk, digital video disk) playback apparatuses also provided with the function of playing CDs (compact disks) have appeared on the market so that viewers may enjoy the played video of DVDs on a television screen. With such a DVD playback apparatus, the user must operate the DVD playback apparatus through the television screen when playing a CD. Namely, this operation method is called on-screen display (OSD), and it is necessary to operate, using a remote controller or the like, various types of settings relating to the playback of the CD in accompaniment with the on-screen guide of a menu screen displayed on the television screen in a state where the power of the television receiver is ON. The menu displayed on the screen has a hierarchical structure. For example, using the remote controller or the like, the user first selects a folder in a CD playback mode in a main hierarchical menu. When the user selects a folder, an input screen is displayed for receiving the setting of the playback mode, such as repeat playback or program playback. Then, the user inputs a setting relating to the CD playback mode. After moving through the process of this operational input, the user finally reaches the stage where the CD can actually be played and audio can be outputted from the speaker. See, e.g., Japanese Patent Application Laid-open Publication No. 2002-190992.

Additionally, even while the audio is being outputted from the speaker when the CD is actually being played, the DVD playback apparatus and the logo of the manufacturer are displayed on the television screen.

In this background art, the user must move through the process of complicated operational input via the television screen until the CD can actually be played, which is inconvenient and results in cumbersome operational input being forced on the user. Also, even when the CD is being played, a logo that is essentially unnecessary is displayed on the television screen. Not only is this display annoying to the user, but it also unnecessarily consumes the operating power of the television receiver.

### SUMMARY OF THE INVENTION

In order to solve the above and other problems, one aspect of the present invention provides an optical disk playback apparatus that can play a first optical disk in which audio data are recorded and output audio to a speaker, can play a second optical disk in which at least video data are recorded and output video to an external display device, and includes a display panel that can display an operational input status relating to the playback of the first optical disk, the optical disk playback apparatus including: a first operational input status outputting unit that outputs, to the external display device, a video signal for displaying at least operational input statuses relating to the playback of the first optical disk and the second optical disk; a display mode determining unit that determines, in accordance with an operational input that selects an internal display panel display mode that causes the operational input status of the first optical disk to be displayed on the display panel or an external display device display mode that causes that operational input status to be displayed on the display device, the display mode of these; and a second operational input status outputting unit which, when the internal display panel display mode has been selected, causes at least the operational input status of the first optical disk to be displayed on the display panel.

### BRIEF DESCRIPTION OF THE DRAWINGS

For a more complete understanding of the present invention and the advantages thereof, reference is now made to the following description taken in conjunction with the accompanying drawings wherein:

FIG. 1 is a functional block diagram of an optical disk playback apparatus pertaining to an embodiment of the invention;

FIG. 2 is a flow chart showing a display operation corresponding to a type of an optical disk and a type of recorded data according to the optical disk playback apparatus pertaining to the invention; and

FIG. 3 is a flowchart showing another display operation corresponding to a type of an optical disk and a type of recorded data according to the optical disk playback apparatus pertaining to the invention.

### DETAILED DESCRIPTION OF THE INVENTION

At least the following will become apparent from the description of the specification and the attached drawings.

One aspect of the present invention provides an optical disk playback apparatus that can play a first optical disk in which audio data are recorded and output audio to a speaker, can play a second optical disk in which at least video data are recorded and output video to an external display device, and includes a display panel that can display an operational input status relating to the playback of the first optical disk, the optical disk playback apparatus including: a first operational input status outputting unit that outputs, to the external display device, a video signal for displaying at least operational input statuses relating to the playback of the first optical disk and the second optical disk; a display mode determining unit that determines, in accordance with an operational input that selects an internal display panel display mode that causes the operational input status of the first optical disk to be displayed on the display panel or an external display device display mode that causes that operational input status to be displayed on the display device, the display mode of these; and a second operational input status outputting unit which, when the internal display panel display mode has been selected, causes at least the operational input status of the first optical disk to be displayed on the display panel.

Thus, in the case of the display mode that displays on the internal display panel, the operational input status relating to the playback of the first optical disk is displayed on the display panel. Thus, when playing an optical disk such as a music CD or the like and outputting audio, the operational input status relating to a playback operation, such as play, stop, or repeat, can be displayed on the display panel such as an LCD or the like without being displayed on the external display device such as a television receiver or the like with so-called OSD. Additionally, the user can enjoy a rapid and simple operation while viewing the display of the display panel without the intervention of the television receiver.

Thus, when simply playing a music CD or the like and outputting audio from a speaker, the display of the television screen that is unnecessary to the user can be eliminated, and a user-friendly operating environment can be provided in the same manner as a simple playback apparatus provided with only the function of playing a music CD. Also, because the unnecessary display of the television screen can be eliminated, the annoying operation of turning ON and OFF the power of the television receiver can be omitted, and the consumed power therefor can be reduced.

Also, the first optical disk may be a compact disk, and the second optical disk may be a digital versatile disk.

Moreover, the display mode determining unit may discriminate the first optical disk or the second optical disk, and in accordance with the discrimination result, determine the internal display panel display mode or the external display device display mode.

Thus, in addition to the operation by the user of selecting the display mode, the operational input status can be displayed on the external display device or the internal display panel in accordance with the type of the optical disk.

Also, when the display panel display mode has been selected, the first operational input status outputting unit may output, to the second operational input status outputting unit, data relating to the operational input status of the first optical disk.

Thus, in regard to the playback of the first optical disk, the second operational input status outputting unit can acquire data relating to the operational input status. Thus, when playing the first optical disk, the operational input status set in the past can be reused, and the user does not have to again conduct an operational input. Thus, a user-friendly operating environment can be provided.

Moreover, when the display panel display mode has been selected, the first operational input status outputting unit may cause the fact that the display mode is the display panel display mode to be displayed on the external display device in place of the operational input status of the first optical disk.

Moreover, the first operational input status outputting unit may be configured by a microcomputer and integrated in a circuit together with a unit that processes the playback of the first optical disk and the second optical disk.

Also, the second operational input status outputting unit may be configured by a microcomputer and include a display driver for sending a display signal to the display panel on the basis of the data.

<<Overall Configuration>>

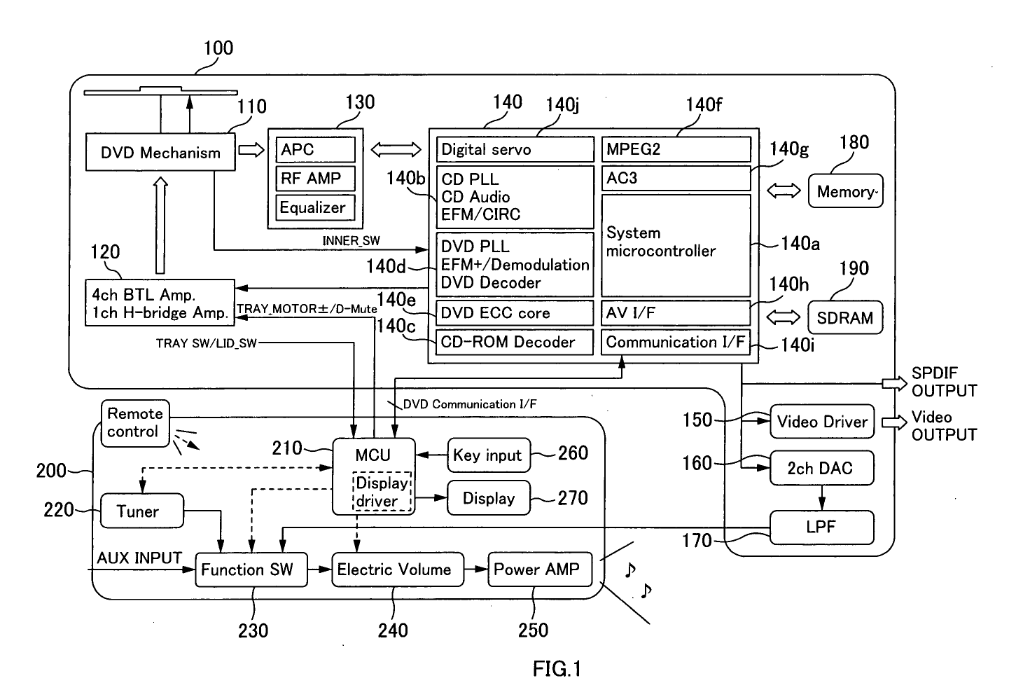

The configuration of an embodiment of an optical disk playback apparatus pertaining to the invention will be described with reference to the block diagram of FIG. 1. The optical disk playback apparatus is configured to play various types of optical disks, such as a CD (first optical disk) and a DVD (second optical disk). For example, at least audio data are recorded in a CD, and at least video data are recorded in a DVD. The optical disk playback apparatus is configured by an optical disk drive playback system block 100 and a control system block 200. The optical disk drive playback system block 100 includes an optical disk drive mechanism 110, a mechanism driver 120, an RF amp 130, a decoder unit 140, a video driver 150, a D/A converter 160, a low pass filter (LPF) 170, a frame memory 180, and a synchronous dynamic random access memory (SDRAM) 190.

The control system block 200 includes a controller (display mode determining unit, second operational input status outputting unit) 210, a tuner 220, a function selection switch circuit 230, an electric volume circuit 240, an audio amp 250, an operational key input interface 260, and a display panel 270.

First, the optical disk drive playback system block 100 will be described. The optical disk drive mechanism 110 includes a spindle motor, which causes the optical disk to rotate, and an optical pickup. The mechanism driver 120 generates a focus servo signal, a tracking servo signal, a pickup motor-use feed control signal and a spindle servo signal in order to drive the spindle motor and the optical pickup, and outputs these signals to the optical disk drive mechanism 110. The RF amp 130 is integrated with an automatic phase control (APC) and an equalizer in a single chip. The RF amp 130 amplifies an RF signal obtained from the optical pickup of the optical disk drive mechanism 110, conducts necessary processing with respect to the RF signal, and sends the amplified RF signal to the decoder unit 140.

The decoder unit 140 is configured as a playback processor capable of accommodating various types of optical disks, such as a CD and a DVD, and includes various types of circuits that are integrated in a single chip. The various types of circuits configuring the decoder unit 140 include a system controller (first operational input status outputting unit) 140a, a CD playback processor 140b, a CD-ROM decoder 140c, a DVD playback processor 140d, a DVD-use error collection code (ECC) processor 140e, an MPEG2 video processor 140f, an AC3 audio processor 140g, an AV interface 140h, a communication interface 140i, and a servo controller 140j. The system controller 140a is configured by a microcomputer and controls the playback processing operation in accordance with a clock signal and data from the controller 210 of the control system block 200. The CD playback processor 140b includes a phase locked loop (PLL) circuit, an EFM demodulator circuit, and a circuit for correcting errors. The DVD playback processor 140d includes a PLL circuit and an EFM demodulator circuit.

In the decoder unit 140 with this configuration, the various circuits 140a to 140j, the frame memory 180 and the SDRAM 190 cooperate to execute playback processing of a DVD and a CD on the basis of the RF signal from the RF amp 130. As a result of this playback processing, error-corrected data bits are converted to audio signals by the D/A converter 160, and the audio signals are inputted to the function selection switch circuit 230 via the LPF 170 as an L signal and an R signal. The L signal and R signal inputted to the function selection switch circuit 230 are outputted to an external speaker via the electric volume circuit 240 and the audio amp 250. Also, a playback signal obtained by the decoder unit 140 is sent as a video signal to an external television receiver via the video driver 150. Moreover, the servo controller 140j sends, to the mechanism driver 120, the various types of aforementioned signals necessary for the drive of the spindle motor and the optical pickup.

Next, the control system block 200 will be described. The controller 210 is configured by a microcomputer and controls all of the optical disk drive playback system block 100, the tuner 220, the function selection switch circuit 230, the electric volume circuit 240, the audio amp 250 and the display panel 270 in accordance with a signal from the operational key input interface 260.

The operational key input interface 260 includes an interface, such as switches, buttons and a remote control receiver, in order to receive the operational input from the user. The operational key input interface 260 outputs, to the controller 210, an operational input signal relating to the function of playing an optical disk such as a CD or DVD and a radio function in accordance with the operational input of the user beginning with turning the power ON or OFF. When the function of playing an optical disk is selected in accordance with the operational input signal, the controller 210 sends predetermined data to the system controller 140a of the optical disk drive playback system block 100 and causes the operation of playing the optical disk to be executed. When the radio function is selected, the controller 210 causes a radio signal from the tuner 220 to be inputted to the audio amp 250 via the function selection switch circuit 230 and the electric volume circuit 240, and causes radio audio to be outputted from the external speaker. It will be noted that the controller 210 similarly causes an audio signal from an external input (AUX INPUT) to be inputted to the audio amp 250 and causes radio audio to be outputted from the external speaker.

The controller 210 is provided with a display driver, and causes a display signal to be outputted from the display driver to the display panel 270 so that various types of information such as the operational input status including the status of the playback operation can be displayed. The display panel 270 is configured by an LCD or an LED for displaying the operational input and the playback status used in a compact component stereo system. Namely, the display panel 270 has only the function of displaying various types of information on the basis of the output signal from the display driver, and does not have the function of displaying a playback image of the optical disk.

Examples of the various types of information displayed include the reception status of the operational input of the user, the ON status of the power representing the operating status of the entire optical disk playback apparatus, the band type (AM/FM) and the counted reception frequency in the case of the radio function, and the type of the optical disk, the operating status, the track number and the playback mode in the case of the optical disk playback function.

The details will be described later, but the various types of information displayed in this manner are not only displayed on the display panel 270, but also on the television receiver on which the video signal from a DVD or the like is displayed as a result of the operational input. Namely, the controller 210 sends data to the system controller 140a through the communication interface 140i of the optical disk drive playback system block 100 so that the various types of information are displayed on the television receiver. On the basis of these data, the system controller 140a causes a video signal to be sent from the video driver 150 to the television receiver so that the various types of information are displayed.

For example, the operational input relating to a playback mode such as repeat playback and program playback of a CD is recorded, set and registered in a memory incidental to the system controller 140a and retained as data relating to that operational input.

<<Display Operation Corresponding to the Type of the Optical Disk and the Type of the Recorded Data>>

The display operation corresponding to the type of the optical disk and the type of the recorded data will now be described with respect to displaying the various types of information such as the operational input status including the status of the playback operation in the optical disk playback apparatus having the configuration described with reference to FIG. 1.

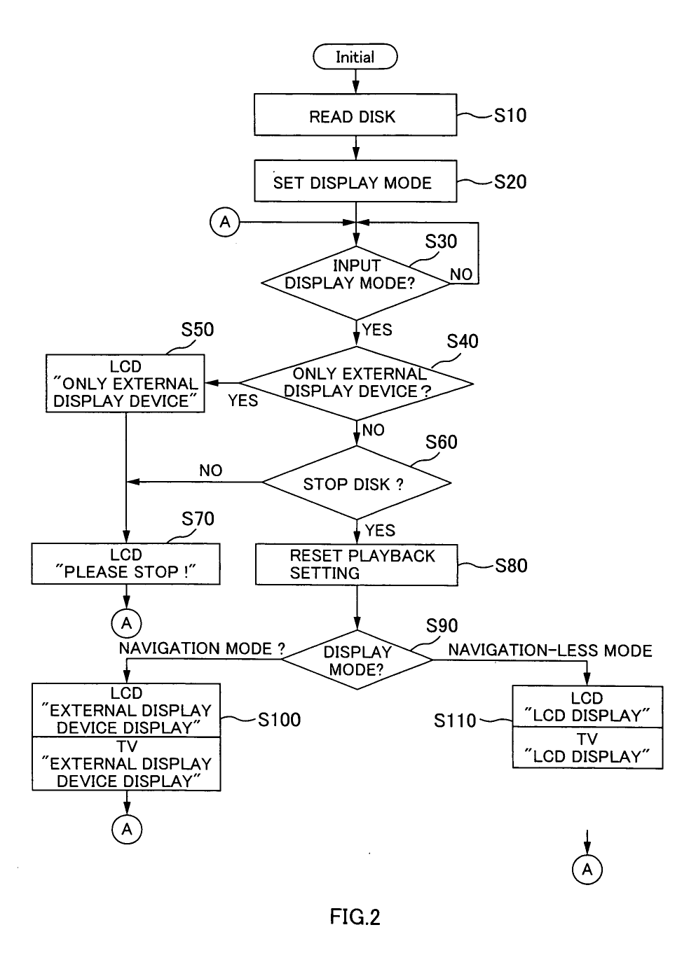

First, as shown in the flow chart of FIG. 2, the various types of information including the type of the optical disk are read from an information storage region of the optical disk (S10). The controller 210 discriminates the type of the optical disk and the type of the recorded data. In accordance with the discrimination result, the controller 210 initially sets the display mode to an external display device display mode (navigation on, OSD), which causes the statuses of the operational input and the playback operation of the optical disk to be displayed on an external display device, or an internal display panel display mode (navigation off), which causes the statuses of the operational input and the playback operation of the optical disk to be displayed on the internal display panel (S20).

The optical disk corresponding to the internal display panel display mode is a CD in which audio data are recorded or an optical disk in which audio data in MP3 format are recorded, for example. The optical disk corresponding to the external display device display mode is a DVD or video CD in which video data are recorded or an optical disk in which video data in JPEG format are recorded. It will be noted that data relating to the corresponding relationship of the two aforementioned display modes corresponding to the type of the optical disk and the type of the recorded data are prerecorded in a memory incidental to the controller 210.

Then, the operational input selecting whether to turn ON or OFF the external display device display mode with a remote control operation or the like by the user is waited upon (S30: NO). When there is an operational input (S30: YES), if the optical disk is of a type that only corresponds to the external display device display mode (e.g., a DVD or video CD in which video data are recorded, or an optical disk in which video data in JPEG format are recorded) (S40: YES), the internal display panel displays the fact that the display mode is the external display device display mode (S50), and the routine returns to the processing of S30.

Conversely, when the determination at S40 is NO, it is determined whether or not the optical disk is stopped without rotating, and if it is not stopped (S60: NO), the internal display panel displays the fact that a stop operation is requested (S70), and the routine returns to the processing of S30. When the optical disk is stopped without rotating (S60: YES), the controller 210 and the system controller 140a erase the incidental memory (RAM) and reset the setting relating to the optical disk playback mode (e.g., program playback or random playback) (S80). Namely, the user again operationally inputs the playback mode in the playback of the optical disk.

Then, in S20, when the display mode is set to the external display device display mode, the internal display panel 270 and the external display device display for a few seconds the fact that the display mode is the external display device display mode (navigation mode) (S90 to S100), and the routine returns to the processing of S30.

In S20, when the display mode is set to the internal display panel display mode, the internal display panel 270 displays for a few seconds the fact that the display mode is the internal display panel display mode, the external display device displays the fact that the display mode is this mode (S90 to S100) during the internal display panel display mode (navigation mode), and the routine returns to the processing of S30.

In the internal display panel display mode, display is done on the internal display panel. Thus, when playing an optical disk such as a music CD and outputting audio, the operational input status relating to the playback operation, such as play, stop, and repeat, can be displayed on a display panel such as an LCD without being displayed on an external display device such as a television receiver using so-called OSD. Additionally, the user can ejoy a quick and simple operation while viewing the display panel and not through the television receiver.

Thus, when simply playing a music CD or the like and outputting audio from a speaker, the display of the television screen that is unnecessary to the user can be eliminated, and a user-friendly operating environment can be provided in the same manner as a simple playback apparatus provided with only the function of playing a music CD. Also, because the unnecessary display of the television screen can be eliminated, the annoying operation of turning ON and OFF the power of the television receiver can be eliminated, and the power consumed therefor can be reduced.

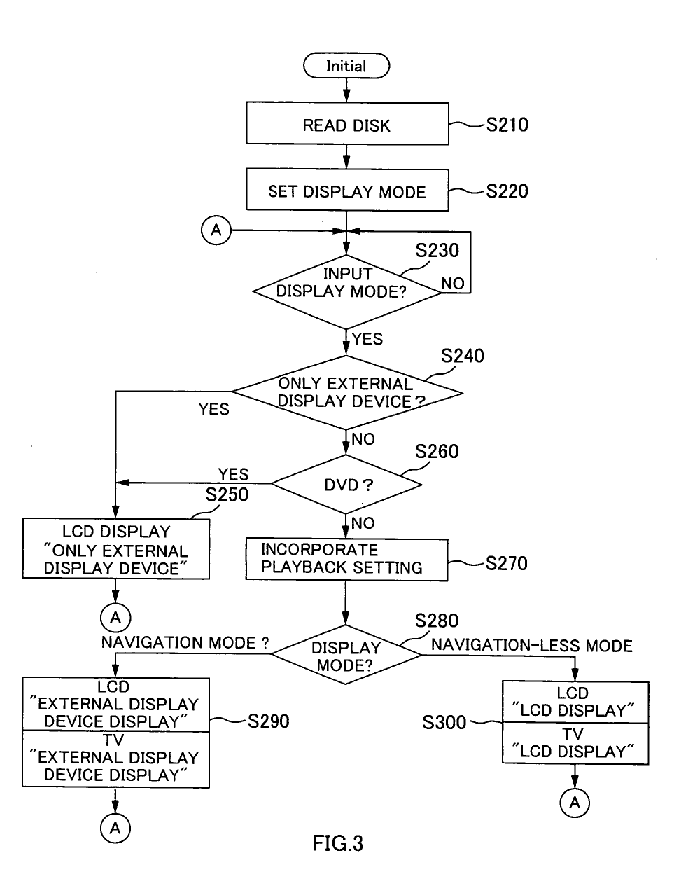

Next, an example of an operation that is different from the display operation described with reference to the flow chart of FIG. 2 will be described with reference to the flow chart of FIG. 3. First, the various types of information including the type of the optical disk are read from the information storage region of the optical disk (S210). The controller 210 discriminates the type of the optical disk and the type of the recorded data. In accordance with the discrimination result, the controller 210 initially sets the display mode to the external display device display mode (navigation on) or the internal display panel display mode (navigation off) (S220).

Then, the operational input selecting whether to turn ON or OFF the external display device display mode with a remote control operation or the like by the user is waited upon (S230: NO). When there is an operational input (S230: YES), if the optical disk is of a type that only corresponds to the external display device display mode (S240: YES), the internal display panel displays the fact that the display mode is the external display device display mode (S250), and the routine returns to the processing of S230.

Conversely, when the determination of S240 is NO, it is determined whether or not the optical disk is a DVD, and if the optical disk is a DVD (S260: YES), the internal display panel displays the fact that the display mode is the external display device display mode (S250). If the optical disk is not a DVD (S240: NO), the controller 210 acquires setting data relating to the playback mode of the optical disk from the system controller 140a (S270). Specifically, the system controller 140a outputs, to the controller 210, setting data relating to the playback mode of the optical disk. Namely, in playing the optical disk, it is not necessary for the user to again operationally input the playback mode.

Next, in S220, when the display mode is set to the external display device display mode, the internal display panel 270 and the external display device display for a few seconds the fact that the display mode is the external display device display mode (navigation mode) (S280 to S290), and the routine returns to the processing of S230. In S220, when the display mode is set to the internal display panel display mode, the internal display panel 270 displays for a few seconds the fact that the display mode is the internal display panel display mode (navigation-less mode), the external display device displays the fact that the display mode is this mode (S280 to S290) during the internal display panel display mode, and the routine returns to the processing of S230.

As described hereinabove, according to the embodiments of the present invention, in the case of the display mode that displays on the internal display panel, the operational input status relating to the playback of the first optical disk is displayed on the display panel. When playing an optical disk such as a music CD or the like and outputting audio, the operational input status relating to a playback operation, such as play, stop, or repeat, can be displayed on the display panel such as an LCD or the like without being displayed on the external display device such as a television receiver or the like with so-called OSD. Additionally, the user can rapidly conduct a simple operation while viewing the display of the display panel without the intervention of the television receiver.

Thus, when simply playing a music CD or the like and outputting audio from a speaker, the display of the television screen that is unnecessary to the user can be eliminated, and a user-friendly operating environment can be provided in the same manner as a simple playback apparatus provided with only the function of playing a music CD. Also, because the unnecessary display of the television screen can be eliminated, the annoying operation of turning ON and OFF the power of the television receiver can be omitted, and the consumed power therefor can be reduced.

The embodiment described above is merely one example and can be variously changed in a range that does not depart from the spirit of the invention. For example, the function of a television provided with a DVD playback apparatus in which the optical disk playback apparatus pertaining to the invention is integrated with a display device such as an external television receiver is also included in the invention.

1. An optical disk playback apparatus that can play a first optical disk in which audio data are recorded and output audio to a speaker, can play a second optical disk in which at least video data are recorded and output video to an external display device, and includes a display panel that can display an operational input status relating to the playback of the first optical disk, the optical disk playback apparatus comprising:
a first operational input status outputting unit that outputs, to the external display device, a video signal for displaying at least operational input statuses relating to the playback of the first optical disk and the second optical disk;
a display mode determining unit that determines, in accordance with an operational input that selects an internal display panel display mode that causes the operational input status of the first optical disk to be displayed on the display panel or an external display device display mode that causes that operational input status to be displayed on the display device, the display mode of these; and
a second operational input status outputting unit which, when the internal display panel display mode has been selected, causes at least the operational input status of the first optical disk to be displayed on the display panel.

2. The optical disk playback apparatus of claim 1, wherein the first optical disk is a compact disk.

3. The optical disk playback apparatus of claim 1, wherein the second optical disk is a digital versatile disk.

4. The optical disk playback apparatus of claim 1, wherein the display mode determining unit discriminates the first optical disk or the second optical disk, and in accordance with the discrimination result, determines the internal display panel display mode or the external display device display mode.

5. The optical disk playback apparatus of claim 1, wherein when the display panel display mode has been selected, the first operational input status outputting unit outputs, to the second operational input status outputting unit, data relating to the operational input status of the first optical disk.

6. The optical disk playback apparatus of claim 1, wherein when the display panel display mode has been selected, the first operational input status outputting unit causes the fact that the display mode is the display panel display mode to be displayed on the external display device in place of the operational input status of the first optical disk.

7. The optical disk playback apparatus of claim 1, wherein the first operational input status outputting unit is configured by a microcomputer and is integrated in a circuit together with a unit that processes the playback of the first optical disk and the second optical disk.

8. The optical disk playback apparatus of claim 1, wherein the second operational input status outputting unit is configured by a microcomputer and includes a display driver for sending a display signal to the display panel on the basis of the data.
